(19) United States
(12) Patent Application Publication
(10) Pub. No.: US 2009/0249206 A1
(43) Pub. Date: Oct. 1, 2009

(54) METHOD, APPARATUS AND COMPUTER PROGRAM PRODUCT FOR PRESENTING A MEDIA HISTORY

(75) Inventor: Jani Jukka Stahlberg, Kaarina (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/058,319

(22) Filed: Mar. 28, 2008

(51) Int. Cl. G06F 17/00; G06F 3/048

(52) U.S. Cl. 715/716; 700/94

(57) ABSTRACT

A method for presenting a media history may include determining whether actuation of a function initiation mechanism corresponds to a first actuation characteristic or a second actuation characteristic in which the first actuation characteristic is associated with invocation of a first function on a single object of a particular class and the second actuation characteristic is associated with invocation of a second function operable on a plurality of objects of the particular class. The method may further include initiating the first function or the second function based on the determined actuation characteristic. A corresponding apparatus and computer program product are also provided.

### TECHNOLOGICAL FIELD

Embodiments of the present invention relate generally to user interface technology and, more particularly, relate to a method, apparatus and computer program product for providing a user interface enabling access to a media history.

### BACKGROUND

Personal electronic devices are rapidly becoming smaller, more capable and more accessible. Accordingly, personal electronic devices are becoming increasingly common. Due to the ubiquitous nature of such devices, people all over the world and of all walks of life are now utilizing personal electronic devices to execute applications that perform tasks or provide entertainment, communicate with other individuals, entities or contacts and/or to share or consume information, media and other content. Additionally, given recent advances in processing power, battery life, memory and the availability of peripherals such as video/audio recording and playback, personal electronic devices are becoming prolific producers and consumers of media.

Content for consumption by a particular user may be acquired in numerous forms and via numerous mechanisms. For example, it is currently popular to download music, videos and other content in various formats such as MP3 (Moving Picture Experts Group (MPEG)-1 audio layer 3) via a computer or the Internet. The user may then store the content for playback at some time in the future. However, given the relatively large amounts of content that may currently be stored on such devices, difficulties may be experienced in locating a particular content item.

To alleviate such difficulties, various solutions have been developed. For example, search engines, favorite lists, topic specific storage folders, bookmarks, and other mechanisms have been developed to enable a user to locate specific content more efficiently. Furthermore, users may navigate a menu structure to review a history of items recently played or downloaded. However, these mechanisms for examining content or a history of recently played content typically involve a relatively large number of key selections or operational inputs for initiation. Meanwhile, as indicated above, the devices are continuing to shrink in size. Accordingly, the user interface may also experience limitations in size and/or number of operational interface mechanisms (e.g., buttons or keys) thereby making using any of the solutions above less desirable or less efficient.

Accordingly, it may be desirable to provide another mechanism by which users may locate media content, which may overcome at least some of the disadvantages described above.

### BRIEF SUMMARY

A method, apparatus and computer program product are therefore provided to enable the provision of a media history. For example, a method, apparatus and computer program product are provided that may enable a user to access a history of media items rendered by a media player. In this regard, for example, an exemplary embodiment may provide a history in the form of a list of recently played items that may be accessible via activation of a function initiation device or mechanism such as a button or key. More specifically, an exemplary embodiment may provide that the history may be accessible via activation of the button in which the button has multiple functions associated therewith and the manner of activation determines which of such functions is executed. Accordingly, for example, information on recently played or otherwise accessed media or other content may be provided to the user via a relatively simple and efficient operation.

Embodiments of the invention may provide a method, apparatus and computer program product for advantageous employment in mobile environments, such as on a mobile electronic device capable of rendering content items related to various types of media. As a result, for example, users of such devices may enjoy an improved content access capability and a corresponding improved ability to locate and experience content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 illustrates a user interface of an electronic device according to an exemplary embodiment of the present invention;

FIG. 2 illustrates a block diagram of portions of an apparatus for presenting a media history according to an exemplary embodiment of the present invention;

FIG. 3 illustrates an example of a display generated by the apparatus in response to selection of the button in accordance with a first actuation characteristic according to an exemplary embodiment;

FIG. 4 illustrates an example of a display generated by the apparatus in response to selection of the button in accordance with a second actuation characteristic according to an exemplary embodiment of the present invention; and

FIG. 5 is a flowchart according to an exemplary method for providing a media history according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

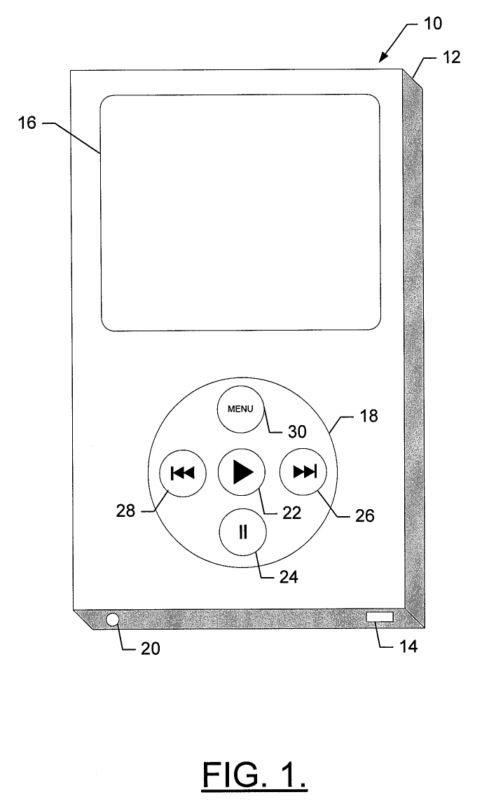

FIG. 1, one aspect of the invention, illustrates a user interface of an electronic device 10 according to an exemplary embodiment of the present invention. In this regard, the device 10 of FIG. 1 may be utilized for media rendering and/or storage. However, the device 10 need not be limited to functionality relating to rendering and/or storing media. As such, for example, the device 10 could also include other capabilities. Thus, it should be understood that the device 10 as illustrated and hereinafter described is merely illustrative of one type of device that may benefit from embodiments of the present invention and, therefore, should not be taken to limit the scope of embodiments of the present invention. As such, the elements shown in FIG. 1 are representative of one exemplary embodiment and other embodiments may include additional or even fewer elements than those shown in FIG. 1. While embodiments of the device 10 will be hereinafter described for purposes of example, other types of devices, such as portable digital assistants (PDAs), pagers, mobile televisions, mobile telephones, mobile messaging devices, gaming devices, laptop computers, cameras, video recorders, audio/video player, radio, GPS devices, tablets, Internet capable devices, or any combination of the aforementioned, and other types of voice and text communications systems, can readily employ embodiments of the present invention.

As shown in FIG. 1, the device 10 may include a casing 12, which may be utilized to encase and protect components of the device and may be made of any suitable material (e.g., plastic, metal, composite materials, etc.). The device 10 may also include an external interface 14 configured to enable the device 10 to be placed in communication with other devices. The external device interface 14 could be used to enable wireless or wired communications with other devices such as for the purposes of acquiring or sharing content. As such, the external device interface 14 could be a wired connection socket or port (e.g., universal serial bus (USB), fiber optic or other connection ports) or a wireless connection mechanism (e.g., Bluetooth, wireless universal serial bus (WUSB), or other mechanism such as an antenna or antennas with a corresponding transmitter and receiver). Accordingly, although content accessible to the device 10 may be stored on the device 10 in some embodiments, in alternative embodiments the content may be not necessarily reside on the device 10, but may instead be accessed from another source. For example, the device 10 may access content via the external device interface 14. In this regard, the accessed content may be streamed, downloaded or otherwise transferred to the device 10 from another device, a service, a network such as the Internet, or other external sources.

The device 10 may also include various user interface elements such as, for example, a display 16, an input mechanism 18, and an output mechanism 20. The display 16 may be, for example, a liquid crystal display (LCD) or any other display suitable for use in the device 10. In some embodiments, the display 16 may be considered part of the input mechanism 18 (e.g., in the context of a touch screen display) and/or a part of the output mechanism 20 (e.g., in the context of displaying media content, touch screen interface elements (e.g., a touch keypad), etc.). The output mechanism 20 may include an audio output jack for enabling the connection of a headphone or external speaker. Alternatively, the output mechanism 20 may itself include one or more speakers.

The input mechanism 18 may include, as shown in FIG. 1, a keypad comprising one or more keys or buttons. Each key or button may be an example of a function initiation device or mechanism, the activation of which (e.g., by pressing or otherwise selecting) may cause execution of a corresponding function. For example, FIG. 1 shows a play button 22, a pause button 24, a fast forward button 26, a rewind button 28, and/or a menu button 30. However, the input mechanism 18 could also or alternatively include a keypad that may include the conventional numeric (0-9) and related keys (#, *), and other hard and soft keys used for operating the device 10. Alternatively, the keypad may include a conventional QWERTY keypad arrangement and/or may also include various soft keys with associated functions. In addition, or alternatively, the input mechanism 18 may include a joystick, scrolling device or other user input interface. In some instances, the input mechanism 18 may be embodied as a touch screen, as indicated above, and/or the input mechanism 18 may include a microphone to enable the receipt of voice commands or the recording of audible content at the device 10.

According to this example, the play button 22, the pause button 24, the fast forward button 26 and the rewind button 28 may be used to perform conventional functions associated with each respective button in response to normal selection of each respective button. Thus, for example, pressing the play button 22 in a normal manner may initiate the playing or rendering of a media content item (e.g., a selected media content item). Selection of the menu button 30 may enable access to various other functions and/or menu items. For example, selection of the menu button 30 may enable the user of the device 10 to navigate through storage files of the device 10 to find desired content for rendering. In some embodiments, when in a navigation mode (e.g., browsing menu items accessed via selection of the menu button 30), the input mechanism 18 may convert its function to a directional scroll device enabling navigation through various files or amongst various menu items within a selected folder or storage location. In this regard, for example, while in the navigation mode, pressing any of the pause button 24, the fast forward button 26, the rewind button 28, and the menu button 30 may result in navigation in a corresponding direction (e.g., highlighting a lower content item in a listing of content items in response to selection of the pause button 24). Meanwhile, selecting the play button 22 in the navigation mode may enable selection of a currently highlighted content item.

As can be seen from the example above, in an exemplary embodiment, the buttons of the input mechanism 18 may have multiple functions. For example, in a normal mode, pressing the play button 22 may play a content item. Meanwhile, in the navigation mode, pressing the play button 22 may result in selection (but not necessarily playing) of a corresponding menu item. However, the different functions associated with a particular key according to the example above are associated with different classes of objects. In this regard, a content item (e.g., a media file such as a video or audio file) that may be played in response to selection of the play button 22 may be considered one class of object (e.g., media objects) while a menu item selected in the navigation mode may be considered a different class of object (e.g., a functional operator). As such, a particular class of objects may be considered to be one type of object. For example, media content of a particular format or encoded in a particular way may be one type of object, while media content of a different format may be another type or class of object. As another example, media content in general could be one class of objects, while contacts, call history data, documents, etc., may each be other classes of objects.

The employment of multiple functionality buttons described above (e.g., different functions for a key associated with different classes of objects) may be considered somewhat conventional (e.g., in one mode a particular button may be operated to invoke a particular operation on a first class of objects (e.g., calling a contact when a call button is normally pressed), while in another mode the particular button may be operated to invoke a different operation with respect to a different class of objects (e.g., listing missed or received calls or dialed numbers)). However, some embodiments of the present invention may enable multiple functionality buttons that may perform different operations on objects of the same class.

In this regard, for example, according to an exemplary embodiment, a multiple functionality button may be provided that may enable different operations on objects of the same class based on respective different actuation characteristics. An actuation characteristic may be considered a particular way of actuating the button with respect to timing associated with the actuation or pressing of the button (e.g,. duration of press or even sequence of pressing if multiple sequential presses are allowed). As such, differences in actuation characteristics may represent measurably different activities associated with actuation of the same key. For example, pressing the play button 22 according to a first actuation characteristic (e.g., a single press and release of a relatively short duration such as less than one second) may have a first effect or invoke a first operation with respect to a particular object class (e.g., playing a media file). Meanwhile, pressing the play button 22 according to a second actuation characteristic (e.g., a single press of a relatively long duration such as longer than two seconds) may have a second effect or invoke a second and different operation with respect to the particular object class (e.g., providing a history of media files played). Thus, in general terms, embodiments of the present invention may enable the provision of a multiple functionality function initiation mechanism (e.g., a multiple function button) that is enabled to provide at least two different operations with respect to a same object class based on an actuation characteristic of an action actuating the function initiation mechanism.

Furthermore, in an exemplary embodiment, the functions performed with respect to the same object class may be related to different types of functions. In this regard, for example, although one may conceive of a multiple functionality play button that plays content in response to a single button push of short duration, pauses in response to a long duration button push and fast forwards the content in response to a double push (e.g., two short duration pushes in rapid succession) to thereby perform the same type or class of function with respect to the respective class of object (e.g., a media file), embodiments of the present invention may further provide that a different type or class of function may be performed in response to each different actuation characteristic sensed with respect to the multiple functionality button of an embodiment of the present invention. In this regard, a particular class of function may be considered any function performed with respect to a certain characteristic of a given object. Thus, for example, play, fast forward, rewind and stop may all be considered one class of function since they may all impact rendering of a video or audio file. Meanwhile, edit, modify, create and delete may be considered to be another class of function since they may all relate not to rendering of a file, but to altering the content itself.

As an example of providing that a different type or class of function may be performed in response to each different actuation characteristic sensed with respect to the multiple functionality button of an embodiment of the present invention, instead of merely altering play speed for each different actuation characteristic, embodiments of the present invention may enable the provision of playing content in response to sensing a first actuation characteristic with respect to the play button 22 (e.g., a single short duration button press), while enabling the provision of a media history in response to sensing a second and different actuation characteristic with respect to the play button 22 for the same class of object (e.g., pressing and holding the play button 22 while playing or browsing with respect to a particular media file). As such, a first operation may be performed with respect to only the particular object associated with the actuation of the play button 22 (e.g., playing the particular media file) according to a first actuation characteristic and a second operation may be performed with respect to not only the particular object, but also with respect to other objects (e.g., showing a history of recently played media content) in response to actuation of the play button 22 according to a second actuation characteristic. Thus, in general terms, embodiments of the present invention may enable the provision of a multiple functionality function initiation mechanism (e.g., button) that is enabled to provide two different operations with respect to a same object class based on an actuation characteristic of an action actuating the function initiation mechanism, in which the first function impacts only a single object, while the second function impacts a plurality of objects.

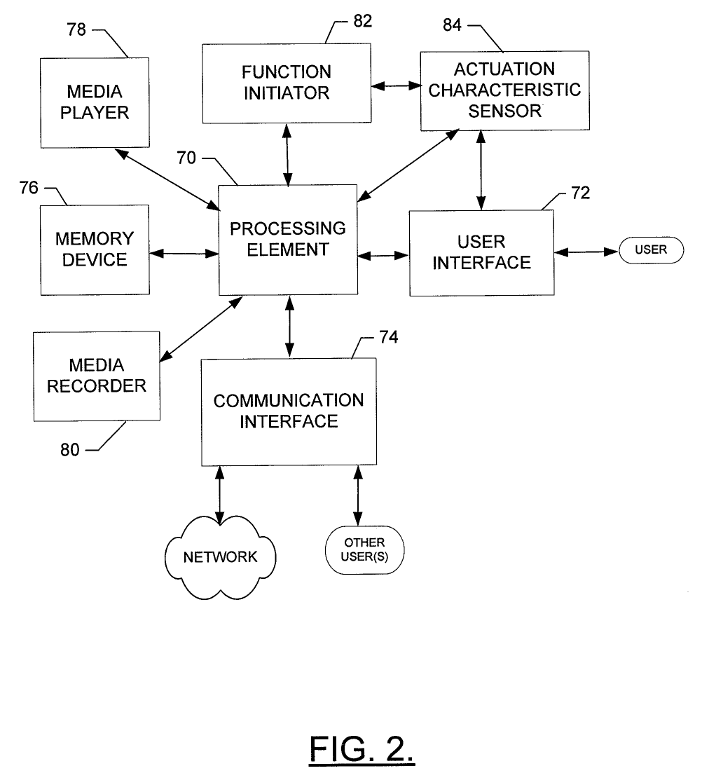

FIG. 2 illustrates a block diagram of portions of an apparatus for presenting a media history according to an exemplary embodiment of the present invention. The apparatus of FIG. 2 may be employed, for example, on the device 10 of FIG. 1. However, it should be noted that the apparatus of FIG. 2, may also be employed on a variety of other devices, both mobile and fixed, and therefore, embodiments of the present invention should not be limited to application on devices such as the device 10 of FIG. 1. Moreover, it should be noted that the devices or elements described below may not be mandatory and thus some may be omitted in certain embodiments.

FIG. 2 is a diagram illustrating an apparatus configured to enable the provision of different functions associated with actuation of the same button or key based on the actuation characteristic used to invoke the button's function according to an exemplary embodiment of the present invention. As shown in FIG. 2, the apparatus (e.g., the device 10 or a portion of the device 10) may include various entities, some of which may be in communication with each other and configured in order to enable practicing embodiments of the present invention. In this regard, the apparatus may include or otherwise be in communication with a processing element 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processing element 70. Additionally or alternatively, the memory device 76 could be configured to store instructions for execution by the processing element 70. As yet another alternative, the memory device 76 may be one of a plurality of databases that store information in the form of static and/or dynamic information to associate various pieces of information with each other or with events, functions, entities, etc.

The processing element 70 may be embodied in a number of different ways. For example, the processing element 70 may be embodied as a processor, a coprocessor, a controller or various other processing means or devices including integrated circuits such as, for example, an ASIC (application specific integrated circuit) or FPGA (field programmable gate array). In an exemplary embodiment, the processing element 70 may be configured to execute instructions stored in the memory device 76 or otherwise accessible to the processing element 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network. In other words, according to an exemplary embodiment, the communication interface 74 may include or otherwise be a portion of the external device interface 14.

The user interface 72 may be in communication with the processing element 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. As such, in an exemplary embodiment, the user interface 72 may include or be a portion of the input mechanism 18 and/or the output mechanism 20.

In some exemplary embodiments, the apparatus may include a media player 78 and/or a media recorder 80 in communication with (or even embodied as or under the control of) the processing element 70. The media player 78 may include any of a number of different devices configured to provide playback and/or rendering capabilities with respect to media content or files. For example, the media player 78 may include a television (TV) monitor, wireless monitor, game console, PC, stereo and home theater, video and imaging capture and/or playback device, multimedia mobile terminal, etc. In some embodiments, the media player 78 may be embodied as a virtual machine or computer program for rendering or playing back multimedia files via the display and/or speaker of the device 10. As such, for example, the media player 78 may be configured to render audio and/or video data such as in a particular audio or video file that may be downloaded to the device 10 for rendering via the media player 78. One example of a media player may be a flash video player, however, numerous similar media players are also known in the art and could be embodied as the media player 78.

In some embodiments, the media player 78 may include a local buffer (e.g., a live data buffer) for temporary storage of data for rendering via the media player 78. As such, a user may request (e.g., via the user interface 72 or more specifically via the play button 22) that data corresponding to a particular multimedia content file (e.g., a particular music or video file) corresponding to audio or video multimedia content be rendered via the media player 78. In such a scenario, the media player 78 may initiate rendering of the corresponding file, which may be stored, for example, in the memory device 76. However, as an alternative, the corresponding file may be downloaded and buffered temporarily while playing via the media player 78. As such, the media player 78 may ensure that the corresponding file may be accessed for playing by the media player 78 when the file is selected for playback via the user interface 72 as described in greater detail below.

The media recorder 80, if employed, may be in communication with the media player 78 to enable the media recorder 80 to record a content item that is being processed or rendered at the media player 78. As such, the media recorder 80 may include any number of different devices and/or applications (e.g., a digital audio recorder) configured to record content to a computer readable storage medium such as the memory device 76. Thus, the media recorder 80 may be any means such as a device or circuitry embodied in hardware, software or a combination of hardware and software that is configured to record data that is being rendered at the media player 78 or captured by the media recorder 80, for example, via the microphone or another portion of the input mechanism 18. In an exemplary embodiment, the media recorder 80 may include a capability to record data at different quality levels, which may depend, for example, on the type of media being recorded or the mechanism for recording. In an exemplary embodiment, file names and/or icons may be associated with content items based on the quality level of the recording and/or the type of media content.

In an exemplary embodiment, the processing element 70 may be embodied as or otherwise control a function initiator 82 and/or an actuation characteristic sensor 84. The function initiator 82 and the actuation characteristic sensor 84 may each be any means or device embodied in hardware, software, or a combination of hardware and software that is configured to carry out the functions of the function initiator 82 and the actuation characteristic sensor 84, respectively, as described herein. In this regard, for example, the actuation characteristic sensor 84 may be in communication with the user interface 72 in order to determine a characteristic associated with the actuation of a particular key or button. As such, for example, the actuation characteristic sensor 84 may be configured to, for the actuation of a particular key or button, determine characteristics associated with the activity of actuating the particular button such as the length of time that the button was pressed or otherwise selected, the number of times the particular button was pressed sequentially within a predefined period of time, or the like. The actuation characteristic sensor 84 may thereafter be enabled to communicate the determined characteristic (e.g., the actuation characteristic) to the function initiator 82. However, it should be understood that since the processing element 70 may be embodied as both the function initiator 82 and the actuation characteristic sensor 84, there need not necessarily actually be a communication of a message between two entities in order for the function initiator 82 to be informed of the determined characteristic according to some exemplary embodiments.

Once the function initiator 82 is aware of the actuation characteristic, the function initiator 82 may be configured to initiate a function associated with the respective determined actuation characteristic for the actuated button. As such, for example, the function initiator 82 may include or otherwise be enabled to access associations between particular actuation characteristics and their respective functions to enable the function initiator 82 to invoke a function corresponding to a sensed or determined actuation characteristic for the button pushed. As one example, if the play button 22 is pressed with a short duration press, the actuation characteristic sensor 84 may determine that the respective key (e.g., the play button 22) has been pressed with a short duration press (e.g., a first actuation characteristic) and communicate such information to the function initiator 82. Being aware that the play button 22 has been pressed with a short duration press, the function initiator 82 may be configured to invoke (or cause the processing element 70 to invoke) rendering of a particular file that was the object of the button press of the play button 22. Meanwhile, if the play button 22 is pressed with a longer duration press (e.g., greater than two seconds), the actuation characteristic sensor 84 may determine that the respective key (e.g., the play button 22) has been pressed with a relatively long duration press (e.g., a second actuation characteristic) and communicate such information to the function initiator 82. Being aware that the play button 22 has been pressed with a relatively long duration press, the function initiator 82 may be configured to invoke (or cause the processing element 70 to invoke) a display of the media history of recently played objects.

In an exemplary embodiment, the function initiator 82 may be configured to invoke a display of all media objects recently played (e.g., regardless of object class such as video/audio) by the media player 78 or only of those media objects that are of the same class as an object currently being played, most recently played, or currently highlighted. In another exemplary embodiment, rather than the play button 22, a listing of files recently recorded by the media recorder 80 may be presented in response to a long press (or another specific actuation characteristic associated with a function other than recording) of a record button. Similarly, for any of a plurality of different buttons, multiple functionalities may be provided in response to different actuation characteristics and based on which actuation characteristic is sensed for a particular button pushed or selected in which at least one alternate functionality operates on more than one object of the same class as a functionality operative on one object of a particular class. As such, of at least two different functionalities that may be associated with the same key dependent upon which actuation characteristic of the key is sensed, one such functionality may be operable on only one object while the other functionality may be operable on a plurality of objects of the same class as the one object. In an exemplary embodiment, the functionality operable on the plurality of objects may include presenting a historical record with respect to the performance of the other functionality. As such, for example, if the first functionality is playing or recording content (e.g., in response to a short duration or normal press of a play or record button, respectively), the second functionality may be a historical record of recently played or recorded media items (e.g., in response to a button press longer than a predetermined amount of time for the play or record button, respectively).

In particular, according to an exemplary embodiment, when a file is selected for playback by the user using the user interface 72, for example, via a short duration press of the play button 22, the actuation characteristic sensor 84 may determine the short duration press characteristic for informing the function initiator 82. The function initiator 82 may then cause a currently highlighted file to be played. However, if the actuation characteristic sensor 84 had instead sensed a long press, the function initiator 82 may display a history of all objects recently played (or of objects of the same class or in some other way related to the currently playing or highlighted object, if any) for the user to view. Accordingly, the user may be provided with an efficient manner by which to access historical information associated with the user's media library. As an alternative, a listing of highest rated songs may be displayed in response to the long press function being initiated. Rating information could be based on statistics received from an online service, billboard charts or other sources. Numerous other functionalities associated with a plurality of files may also or alternatively be provided.

As indicated above, embodiments of the present invention may apply to a variety of multifunction keys or buttons. For example, in an exemplary embodiment, a relatively short press of the fast forward button 26 or the rewind button 28 may cause each respective normal operation to be invoked (e.g., fast forwarding content for a short press of the fast forward button 26 and rewinding of content for a short press of the rewind button 28). Meanwhile, if a relatively long press (or double press) of either button is pressed another function on a plurality of content items may be invoked. For example, a long press of the fast forward button 26 may cause presentation of a listing of upcoming items (e.g., items in a playlist or queue for downloading), while a long press of the rewind button 28 may cause presentation of a listing of previously played items. As alternative examples, the rewind button 28 (and/or the fast forward button 26) may instead (or additionally if more than two functions are permitted) include long press induced functions like showing recently added files, lowest rated songs, least played songs. In an exemplary embodiment, a long press of a certain key (e.g., the stop button or pause button 24) may provide a listing of skipped files, frequently paused files, most recently paused file, etc. Furthermore, in some embodiments, the user may be enabled to assign secondary (and possibly other) functions associated with each respective actuation characteristic (e.g., via a menu option).

In addition to enabling the application of embodiments of the present invention to a variety of different keys, one or more of the keys may have a plurality of different possible functionalities in which each such functionality is associated with a particular different actuation characteristic. For example, various different timing characteristics with regard to button pressing may each have an associated different functionality. In this regard, as one example, a short press may have a normal functionality while pressing the same button for various longer periods may each have different functionalities. Such functionalities may correspond to respective different ranges of time for which a button press is held (e.g., a less than one second push may have one function associated therewith, a one to three second push may have another function associated therewith, a three to five second push may have yet another function associated therewith, etc.).

In some examples, a visual, mechanical or audible indication of the actuation characteristic sensed may be provided. Thus, for example, after sensing a particular actuation characteristic and providing a response thereto, the user may be informed of which actuation characteristic was sensed so that, if the user accidentally provided an unintended actuation characteristic, the user may be made aware of the accident without incurring the possible frustration of not understanding why the intended response was not received. Furthermore, in some embodiments, a visual or other aid may be provided for informing the user of the potential functions associated with a particular key. Information associated with the aid may be provided in response to selection of a menu item for revealing such information. Alternatively, for example, in the context of a touch screen embodiment, an indication of the potential functions associated with a key that is hovered over may be provided. As yet another example, if timing characteristics are associated with multiple functionalities, a timer (e.g., in bar format) may be displayed to the user with or without an indication of the function associated with the current time range.

In an exemplary embodiment, the function initiator 82 may be configured to provide more information than merely historical information such as a listing of recently played or rendered media. For example, supplemental information may also be provided. In an exemplary embodiment, the supplemental information may be visible in a listing of media items recently played in association with each item in the list, or the supplemental information may be accessed separately for a selected one of the items in the media history provided. Such supplemental information may include information detailing the date and/or time that the media was played or, if such rendering was not completed or interrupted, the supplemental information may inform the user of the position in the interrupted media file at which the interruption occurred. Furthermore, the function initiator 82 may enable the user to select continuation of the rendering of the interrupted file, or replaying such file from the beginning. As such, for example, if an interrupted file is indicated in a media history provided by the function initiator 82 in response to sensing an actuation characteristic associated with an actuation mechanism invoking presentation of the media history, selection of the interrupted file may resume playing of the interrupted file from the point of interruption. As an alternative, selection of the file may replay the interrupted file from the beginning or may present the user with an option to invoke either of the responses above (e.g., resuming or replaying from the beginning).

In an exemplary embodiment, the function initiator 82 may be configured to display a configurable (e.g., by user preference associated with profile information or based on changes made to system settings) or fixed amount of historical information or items. As such, for example, the function initiator 82 may be configured to display a predetermined number of recently played media files (e.g., the N most recently played files). In some embodiments, the function initiator 82 may be configured to display such files in order of which files have been played most recently. As an alternative, the function initiator 82 may be configured to display the most frequently played files instead of the most recently played files. Other historical information may also be used to form the basis for the information displayed by the function initiator 82 in accordance with alternative exemplary embodiments. For example, files downloaded from the most commonly downloaded source, files associated with the same artist, and other associations may be provided in response to function initiation for a determined actuation characteristic for a multiple functionality key or button.

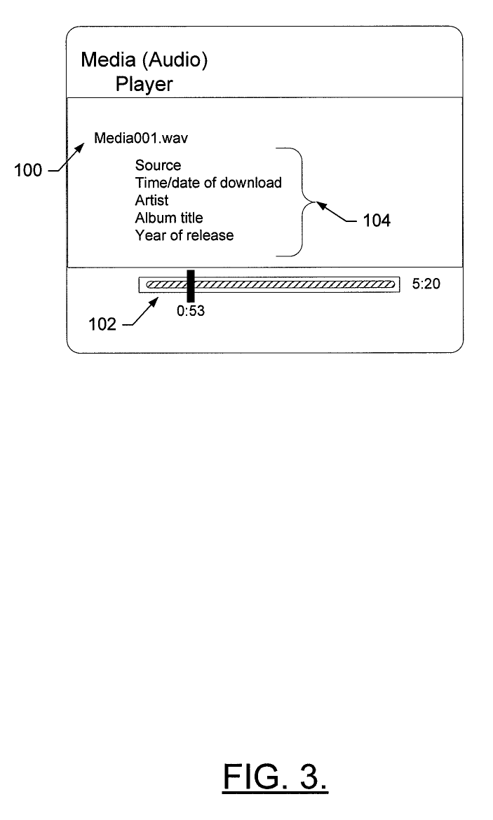

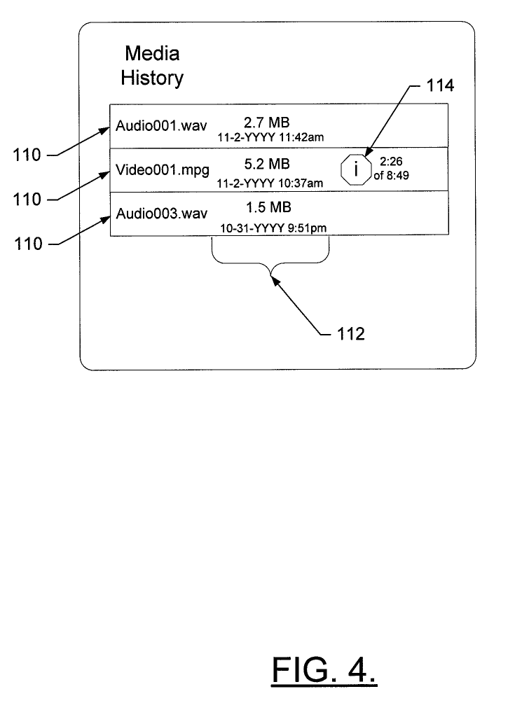

In this regard, FIGS. 3 and 4 illustrate examples of a display that may be generated by the apparatus in response to selection of a multiple functionality button in accordance with alternate actuation characteristics. In this regard, FIG. 3 illustrates an example of a display generated by the apparatus in response to selection of the button (e.g., the play button 22) in accordance with a first actuation characteristic (e.g., a short duration or normal press) according to an exemplary embodiment. As shown in FIG. 3, after pressing the play button 22, a selected file 100 of a particular object class (e.g., an audio file) may be rendered. Information indicative of the status of playing the file 102 may also be presented. Other information 104 could also be presented in accordance with some embodiments. The other information 104 may be indicative of specific details regarding the selected file (e.g., artist, album, source, time/date of download or save, etc.).

Meanwhile, FIG. 4 illustrates an example of a display generated by the apparatus in response to selection of the button (e.g., the play button 22) in accordance with a second actuation characteristic (e.g., a longer duration press) according to an exemplary embodiment. As shown in FIG. 4, after pressing the play button 22 for a relatively long press (e.g., greater than a predetermined time such as two seconds), a history of the N most recently played files may be provided. In this regard, a series of recently played files 110 may be provided in sequential order. Additional information 112 may be provided to indicate relevant data about the respective files. For example, the additional information 112 may include information indicative of file size, time/date of last play, play count, artist, album, source, time/date of download or save, etc. In some embodiments, the additional information 112 may be displayed automatically in the display of media history shown in FIG. 4. However, in other embodiments, the additional information 112 may only be displayed in response to a request for such information or if user configurable settings indicate that such information should be displayed.

In some exemplary embodiments, an icon or other indicator 114 indicating that a particular one of the files among the recently played files 110 was interrupted during playing may be presented, if applicable. In this regard, as shown in FIG. 4, the indicator 114 may indicate at what point during the duration of the respective file the interruption occurred. In an exemplary embodiment, selection of the indicator 114 may enable the user to resume from the point of interruption or begin playing the corresponding file from the start.

According to an exemplary embodiment, the first actuation characteristic associated with any particular key may further be directly associated with a currently highlighted object or an object most recently associated with actuation of the respective key. However, the second actuation characteristic need not be associated with a currently highlighted object or even an object operated on when the key was most recently actuated. Thus, for example, regardless of the current application, actuation of the particular key in accordance with the second actuation characteristic (e.g., the long press of the key) may still cause the function initiator 82 to operate as provided above. Accordingly, in an exemplary embodiment, for example, even if the long press of the play button 22 occurs while the media player 78 is not active, the media player 78 may be launched in response to the long press and/or the media history may be presented to the user.

Embodiments of the present invention may provide that at least a second functionality may be associated with a particular key or button if the respective key or button is activated in a different than normal manner. The second functionality may operate on the same class of objects that the first functionality operates on, but the second functionality may operate on a plurality of objects, while the first functionality operates only on one such object. Thus, the user may be granted quick access to media files without setting specific files into special groups or conducting searching operations. Furthermore, in an exemplary embodiment, the user may be enabled to quickly identify media that was interrupted and replay such media, for example, from the point of interruption.

It should be noted that although embodiments above specifically relate to a multifunction play button, other buttons could employ embodiments of the present invention. Furthermore, although a specific example has been described in the context of displaying a media history, other types of information could also be presented in accordance with exemplary embodiments.

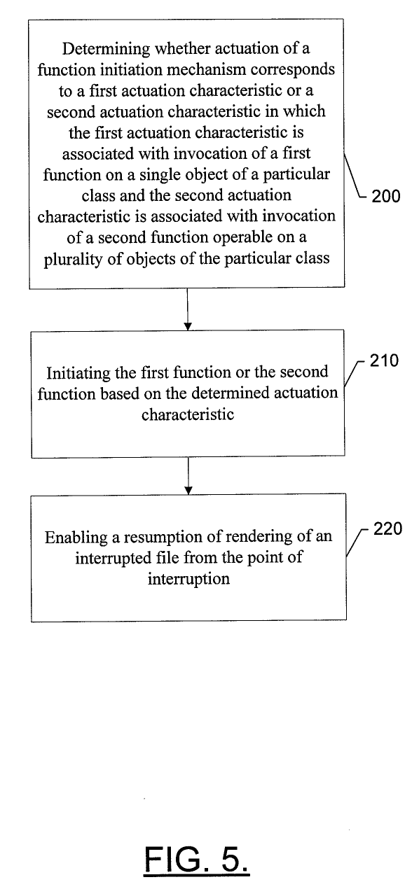

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a personal electronic device and executed by a built-in processor in the device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for enabling generation of media history as illustrated, for example, in FIG. 5 may include determining whether actuation of a function initiation mechanism corresponds to a first actuation characteristic or a second actuation characteristic in which the first actuation characteristic is associated with invocation of a first function on a single object of a particular class and the second actuation characteristic is associated with invocation of a second function operable on a plurality of objects of the particular class at operation 200. At operation 210, the method further provides for initiating the first function or the second function based on the determined actuation characteristic.

In an exemplary embodiment, initiating the second function may include initiation of the second function by presenting a historical record with respect to a performance of the first function. In this regard, for example, presenting the historical record may include presenting historical information related to only objects of the same class or objects of different classes. As an alternative, presenting the historical record may include presenting historical information related to rendered multimedia files. The historical information may include an indicator associated with a file interrupted during presentation indicating a point at which the file was interrupted during presentation. In embodiments in which the indicator is provided, the method may further include an optional operation of enabling a resumption of rendering of the interrupted file from the point of interruption at operation 220.

In an exemplary embodiment, determining whether actuation of the function initiation message corresponds to the first actuation characteristic may include determining whether a button has been actuated for less than a predetermined period of time and determining whether actuation of the function initiation message corresponds to the second actuation characteristic may include determining whether the button has been actuated for more than the predetermined period of time. In alternative exemplary embodiments, initiating the second function may include initiation of the second function by presenting a plurality of recently rendered files or by presenting a plurality of frequently rendered files.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
determining whether actuation of a function initiation mechanism corresponds to a first actuation characteristic or a second actuation characteristic in which the first actuation characteristic is associated with invocation of a first function on a single object of a particular class and the second actuation characteristic is associated with invocation of a second function operable on a plurality of objects of the particular class; and
initiating the first function or the second function based on the determined actuation characteristic.

2. A method according to claim 1, wherein initiating the second function comprises initiation of the second function by presenting a historical record with respect to a performance of the first function.

3. A method according to claim 2, wherein presenting the historical record comprises presenting historical information related to only objects of the same class.

4. A method according to claim 2, wherein presenting the historical record comprises presenting historical information related to objects of different classes.

5. A method according to claim 2, wherein presenting the historical record comprises presenting historical information related to rendered multimedia files.

6. A method according to claim 1, wherein determining whether actuation of the function initiation message corresponds to the first actuation characteristic comprises determining whether a button has been actuated for less than a predetermined period of time and determining whether actuation of the function initiation message corresponds to the second actuation characteristic comprises determining whether the button has been actuated for more than the predetermined period of time.

7. A method according to claim 1, wherein initiating the second function comprises initiation of the second function by presenting a plurality of recently rendered files.

8. A method according to claim 1, wherein initiating the second function comprises initiation of the second function by presenting a plurality of frequently rendered files.

9. A computer program product comprising at least one computer-readable storage medium having computer-readable program code portions stored therein, the computer-readable program code portions comprising:
a first executable portion for determining whether actuation of a function initiation mechanism corresponds to a first actuation characteristic or a second actuation characteristic in which the first actuation characteristic is associated with invocation of a first function on a single object of a particular class and the second actuation characteristic is associated with invocation of a second function operable on a plurality of objects of the particular class; and
a second executable portion for initiating the first function or the second function based on the determined actuation characteristic.

10. A computer program product according to claim 8, wherein the second executable portion includes instructions for initiation of the second function by presenting a historical record with respect to a performance of the first function.

11. A computer program product according to claim 10, wherein the second executable portion includes instructions for presenting historical information related to only objects of the same class.

12. A computer program product according to claim 10, wherein the second executable portion includes instructions for presenting historical information related to objects of different classes.

13. A computer program product according to claim 10, wherein the second executable portion includes instructions for presenting historical information related to rendered multimedia files.

14. A computer program product according to claim 9, wherein the first executable portion includes instructions for determining whether a button has been actuated for less than a predetermined period of time and determining whether actuation of the function initiation message corresponds to the second actuation characteristic comprises determining whether the button has been actuated for more than the predetermined period of time.

15. A computer program product according to claim 9, wherein the first executable portion includes instructions for initiation of the second function by presenting a plurality of recently rendered files.

16. A computer program product according to claim 9, wherein the first executable portion includes instructions for initiation of the second function by presenting a plurality of frequently rendered files.

17. An apparatus comprising a processor configured to:
determine whether actuation of a function initiation mechanism corresponds to a first actuation characteristic or a second actuation characteristic in which the first actuation characteristic is associated with invocation of a first function on a single object of a particular class and the second actuation characteristic is associated with invocation of a second function operable on a plurality of objects of the particular class; and
initiate the first function or the second function based on the determined actuation characteristic.

18. An apparatus according to claim 17, wherein the processor is configured to initiate the second function via initiation of the second function by presenting a historical record with respect to a performance of the first function.

19. An apparatus according to claim 18, wherein the processor is configured to present the historical record by presenting historical information related to only objects of the same class.

20. An apparatus according to claim 18, wherein the processor is configured to present the historical record by presenting historical information related to objects of different classes.

21. An apparatus according to claim 18, wherein the processor is configured to present the historical record by presenting historical information related to rendered multimedia files.

22. An apparatus according to claim 17, wherein the processor is configured to determine whether actuation of the function initiation message corresponds to the first actuation characteristic by determining whether a button has been actuated for less than a predetermined period of time and determining whether actuation of the function initiation message corresponds to the second actuation characteristic comprises determining whether the button has been actuated for more than the predetermined period of time.

23. An apparatus according to claim 17, wherein the processor is configured to initiate the second function via initiation of the second function by presenting a plurality of recently rendered files.

24. An apparatus according to claim 17, wherein the processor is configured to initiate the second function via initiation of the second function by presenting a plurality of frequently rendered files.

25. A user interface comprising:
a processor configured to drive an output device to render content items selected for display via an input from a function initiation mechanism;
an actuation characteristic sensor configured to determine whether actuation of the function initiation mechanism corresponds to a first actuation characteristic or a second actuation characteristic in which the first actuation characteristic is associated with invocation of a first function on a single object of a particular class and the second actuation characteristic is associated with invocation of a second function operable on a plurality of objects of the particular class; and
a function initiator configured to initiate the first function or the second function based on the determined actuation characteristic.
